(19) United States
(12) Patent Application Publication
(10) Pub. No.: US 2013/0151044 A1
(43) Pub. Date: Jun. 13, 2013

(54) SYSTEM AND METHOD OF CONTROLLING TORQUE IN HYBRID VEHICLE

(71) Applicant: Youngdae Lee, Uiwang (KR)

(72) Inventor: Youngdae Lee, Uiwang (KR)

(73) Assignees: KIA MOTORS CORPORATION, Seoul (KR); HYUNDAI MOTOR COMPANY, Seoul (KR)

(21) Appl. No.: 13/553,021

(22) Filed: Jul. 19, 2012

(30) Foreign Application Priority Data
Dec. 9, 2011 (KR) 10-2011-0132283

(51) Int. Cl. B60W 20/00

(52) U.S. Cl. 701/22; 180/65.28; 903/902

(57) ABSTRACT

Disclosed is a system and method of controlling an output of a hybrid vehicle which provides an optimized reserve torque of an engine according to various seven situations. According to the methods of controlling an output of a hybrid vehicle according to exemplary embodiments of the present invention can secure a fuel efficiency of a vehicle and secure a response to and a pursuit of an engine request torque, enhancing drivability and comfortableness of a driver.

### CROSS-REFERENCE TO RELATED APPLICATION

This application claims priority to and the benefit of Korean Patent Application No. 10-2011-0132283 filed in the Korean Intellectual Property Office on Dec. 9, 2011, the entire contents of which are incorporated herein by reference.

### BACKGROUND OF THE INVENTION

(a) Field of the Invention

The present invention relates to a system and method of controlling an output of a hybrid vehicle, and more particularly, to a method of controlling an output of a hybrid vehicle which provides a quick response time by which an output delay does not occur for a request torque of a hybrid control unit (HCU).

(b) Description of the Related Art

Some hybrid vehicles employ a motor operated by an engine and a battery as a power source to assist an output torque of the engine, and an engine clutch for controlling an output torque of the engine is mounted between the engine and the motor.

In these types of hybrid vehicles, a sum of output torques of the engine and the motor through the engine clutch is equal to the input torque of a transmission. Considering fuel efficiency and drivability of the vehicle, hybrid vehicles are typically is first driven in a motor mode (EV), and when it is necessary to provide additional power to the vehicle, the vehicle is operated in a hybrid mode (HEV). In this case, after the engine is turned on and a speed of the engine and a speed of the motor are synchronized with each other, the sum of the engine torque and the motor torque is input to the transmission by engaging the engine clutch.

In this process, a hybrid control unit (HCU), which is a high level control unit, serves to distribute the torques from the engine and the motor, and to distribute an optimum torque to the engine and the motor, considering drivability and fuel efficiency. For example, if the HCU sends, through e.g., the vehicle's controller area network (CAN), a torque request to an engine control unit (ECU) 10 to control the operation of the engine, the ECU 10 adjusts an amount of air intake on the engine according to a requested torque of the HCU to output an engine output torque equal to the requested torque of the HCU.

In the hybrid vehicle, when the HCU determines distribution of the torques of the engine and the motor based on a drive situation and requests an increase/decrease of the torques from the engine and the motor, since the torque of the motor is increased or decreased by an electric signal, the reaction response for the required torque of the HCU due to an increase/decrease in communications transmitted through the network (CAN) in addition to a communication delay can be up to 10 ms.

However, when the HCU requests an increase in the engine torque, a throttle valve is opened through electric throttle control (ETC) to increase the engine torque, increasing an amount of suctioned air. If an amount of measured air increases, a fuel is injected according the amount of air intake. Once the fuel mixed with air enters an engine cylinder and undergoes intake, compression, explosion, and exhaust strokes, the engine may then output the torque requested by the HCU.

If the HCU requires a very high torque, an intake cam mounted to the engine needs to be advanced to secure a large amount of air. In this case, a delay in the hydraulic pressure necessary for the operation of the intake cam may occur. Since the engine requires a certain amount of time for mechanically open the ETC type throttle valve, for introducing the suctioned air into an intake opening, a surge tank, and an intake manifold, and for generating an explosive force as the introduced air is actually burned according to a torque request of the HCU, a natural torque delay occurs in engine torque requests that is not present in motor torque increase request.

Furthermore, when the HCU requests a decrease in torque from the engine, the throttle valve must be closed through the ETC to decrease the engine torque while decreasing an amount of air or retarding an ignition timing to decrease a combustion efficiency of the engine. Thus, the engine torque requested by the HCU can be accurately reduced by simultaneously retarding an ignition timing and reducing an amount of air to decrease the torque based on the requested reduction.

FIG. 1 is a graphical illustration showing the distribution of torques in an engine and a motor when a hybrid vehicle is transitioned from a motor mode (EV) to a hybrid mode (HEV). When a hybrid vehicle is transitioned from the motor mode (EV) to the hybrid mode (HEV), the torque at an input end of a transmission based on the sum of the engine torque and the motor torque is not consistently maintained due to a delay in an output torque of the engine during a distribution of the torques of the engine and the motor, causing a torque dip. Accordingly, a shock or jolting reaction is generated as a result of the sudden increase in torque caused by the delay, thereby making the vehicle, for some people, uncomfortable to drive.

Although a method of detecting an output torque delayed in the engine and compensating the detected output torque with a motor to have a quick response time to improve a deterioration in drivability due to a delay in an output torque of the engine has been applied in some related art, battery power is used to compensate for the engine torque by increasing the torque from the motor. However, this method decreases the state of change (SOC) of the battery. Thus, a charging operation must be performed by the engine due to the decreased SOC, thereby deteriorating fuel efficiency.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a system and a method of controlling an output of a hybrid vehicle, capable of providing a quick response time in response to a requested torque without deteriorating fuel efficiency and without generating a shock due to a torque dip, thereby improving drivability and overall comfort of the vehicle.

In order to solve the above problem, the exemplary embodiments of the present invention provide systems and methods of controlling an output of a hybrid vehicle. An exemplary embodiment of the present invention provides a system and method of controlling an output of a hybrid vehicle. In this embodiment, a control unit determines whether or not an engine is started and is in a partial load state where a torque is controllable, and when engine is in a partial load state, a timer is started and a reserve engine torque is reserved by the control unit. The control unit may continuously monitor the timer and when the set time is exceeded, the engine reserve torque of the engine is set to 0.

Another exemplary embodiment of the present invention provides a system and method of controlling an output of a hybrid vehicle. In this embodiment, a control unit determines whether or not an engine clutch is engaged. When the engine clutch is engaged, a timer is started and an engine reserve torque of the engine is secured. The control unit may continuously monitor the timer to determine whether or not the timer exceeds a set value and whether or not the engine rotation speed is synchronized with the motor rotation speed. Once the timer exceeds the set value, or when the engine speed and the motor speed are synchronized, the reserve engine torque may be set to 0 by the control unit.

Another exemplary embodiment of the present invention provides a system and method of controlling an output of a hybrid vehicle. In particular, a control unit may be configured to determine whether or not an engine clutch is engaged and an engine fuel injection system has been switched from an off state to an on state at a speed which is not less than a preset speed. When the engine fuel injection system has been switched from an off state to an on state, a reserve engine torque is secured by the control unit. The control may be configured to continuously monitor whether or not the timer exceeds a set time and whether or not the speed of the engine is synchronized with the speed of the motor. Once the control unit determines that the timer has exceeded the set time or that the speed of the engine has synchronized with the speed of the motor, controlling the reserve engine torque may be set to 0 by the control unit.

Another exemplary embodiment of the present invention provides a system and method of controlling an output of a hybrid vehicle. In particular, when an engine clutch begins engaging, a control unit determines whether or not an accelerator position sensor (APS) exceeds a specific value. Once the engine clutch engaged and the APS exceeds the specific value. The control unit may be configured to secure a reserve engine torque and determine whether or not has been disengaged and whether the APS is less than the specific value. Once the control unit determines that the engine clutch has been disengaged and the APS is more than the specific value, the control unit may set the reserve engine torque to 0.

Another exemplary embodiment of the present invention provides a system and method of controlling an output of a hybrid vehicle. In particular, a control unit may be configured to determine whether or not an engine torque reserve request has been made by a transmission control unit (TCU) of a vehicle. When an engine torque reserve request has been made, a timer is started and an engine reserve torque is secured. The control unit then monitors the timer to determine when the timer exceeds a set time, and once the set time has been exceeded, the control unit may be configured to set the engine reserve torque to 0.

Another exemplary embodiment of the present invention provides a system and method of controlling an output of a hybrid vehicle. In particular, a control unit may be configured to determine whether or not a difference value between a target request engine torque and a currently requested torque exceeds a set value. When the set value is exceeded, an engine clutch is engaged. A control unit then determines whether or not the difference value between the target request torque of the engine and the currently requested torque is not more than the set value, and when the difference value between the target request engine torque and when the currently requested torque is less than the set value, a reserve engine torque.

Another exemplary embodiment of the present invention provides a method of controlling the output of a hybrid vehicle. More specifically, the method, executed by a control unit includes (a) determining a discharge capacity of a main battery; (b) determining whether an engine clutch is disengaged or engaged; (c) determining whether or not the engine is in a partial load state when a torque is controllable; (d) determining whether or not an RPM of the engine belongs to a preset range; and (e) when all of (a) to (d) are satisfied, securing an engine reserve torque of the engine.

In another exemplary embodiment, an output of the hybrid vehicle is controlled by at least one of the methods of controlling an output of a hybrid vehicle according to the other exemplary embodiments of the present invention. Accordingly, the fuel efficiency of the vehicle can be secured and a response to and a pursuit of a requested torque of the engine can be secured by providing a reserve engine torque that is optimal for various situations, making it possible to improve drivability and comfort of a driver.

### BRIEF DESCRIPTION OF THE DRAWINGS

FIG. 1 is a view showing distribution of torques of an engine and a motor when a hybrid vehicle is transitioned from an EV drive mode to a HEV drive mode.

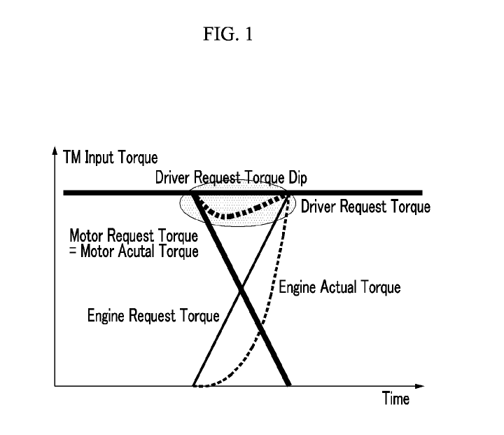

FIG. 2 is a view schematically showing a brake control apparatus of a hybrid vehicle according to an exemplary embodiment of the present invention.

FIG. 3 is a flowchart of a method of controlling an output of a hybrid vehicle according to a first exemplary embodiment of the present invention.

FIG. 4 is a flowchart of a method of controlling an output of a hybrid vehicle according to a second exemplary embodiment of the present invention.

FIG. 5 is a flowchart of a method of controlling an output of a hybrid vehicle according to a third exemplary embodiment of the present invention.

FIG. 6 is a flowchart of a method of controlling an output of a hybrid vehicle according to a fourth exemplary embodiment of the present invention.

FIG. 7 is a flowchart of a method of controlling an output of a hybrid vehicle according to a fifth exemplary embodiment of the present invention.

FIG. 8 is a flowchart of a method of controlling an output of a hybrid vehicle according to a sixth exemplary embodiment of the present invention.

FIG. 9 is a flowchart of a method of controlling an output of a hybrid vehicle according to a seventh exemplary embodiment of the present invention.

### DESCRIPTION OF SYMBOLS

10: ECU

20: HCU

30: MCU

40: battery

50: BMS

60: Engine

70: Motor

80: Engine clutch

90: Transmission

100: Driving wheel

### DETAILED DESCRIPTION OF THE EMBODIMENTS

Hereinafter, exemplary embodiments of the present invention will be described in detail with reference to the accompanying drawings.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum).

Furthermore, control logic utilized to execute the exemplary embodiments of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

Furthermore, the control unit described herein may be embodied as a single control unit or as a plurality of control units without departing from the overall concept and intent of the illustrative embodiment of the present invention.

As those skilled in the art would realize, the described embodiments may be modified in various different ways, all without departing from the spirit or scope of the present invention. The drawings and description are to be regarded as illustrative in nature and not restrictive.

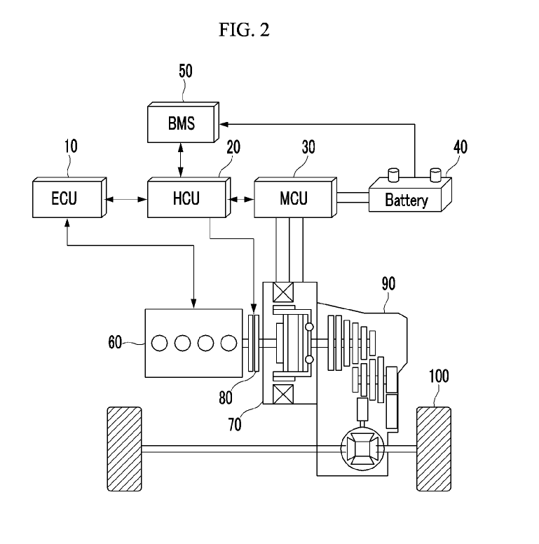

FIG. 2 is a view schematically showing a brake control apparatus of a hybrid vehicle according to an exemplary embodiment of the present invention. The hybrid vehicle applied to the exemplary embodiment of the present invention includes an engine control unit (ECU) 10, a hybrid control unit (HCU) 20, a motor control unit (MCU) 30, a battery 40, a battery management system (BMS) 50, an engine 60, a motor 70, an engine clutch 80, a transmission 90 and a driving wheel 100.

The ECU 10 is connected to the HCU 20 through a network, e.g., a CAN network to control the overall operation of the engine under the control of the HCU 20, secure an engine reserve torque in an output torque of the engine 60 according a torque request of the HCU 20, and provide a quick response time by which an output delay is not generated for the requested torque through control of ignition timing.

The ECU 10 secures an air intake amount which is greater than an amount of air corresponding to a requested torque of the HCU 20 in advance, retards ignition timing to satisfy the requested torque of the HCU 20 through low combustion efficiency, and advances the ignition timing to increase the combustion efficiency when an output torque of the engine 60 is increased, preventing an output torque of the engine 60 from being delayed.

The ECU 10 applies an accelerator position sensor (APS) signal (e.g., a deceleration/acceleration request) of a driver in an operation of securing a reserve engine torque in an output torque of the engine 60 to control the magnitude of output torque.

The HCU 20 integrally controls the controllers through the network according to a drive requests and a vehicle state to control output torques of the engine 60 and the motor 70, and controls the engine clutch 80 according to a drive condition state to control a motor mode (EV), a hybrid mode (HEV) and an engine mode.

The MCU 30 controls the operation of the motor 70 under the control of the HCU 20, and stores recovery brake energy of the motor 70 in the battery 40 during a recovery braking operation.

The battery 40 supplies electric power to the motor 70 in the hybrid mode (HEV) and the motor mode (EV), and electricity recovered through the motor 70 is charged during recovery brake control.

The BMS 50 detects information related to voltage, current, and temperature of the battery 40 to manage and control a state of charge (SOC) and the amount of charged and discharged currents, and provide the information to the HCU 20 through the network.

An overall output torque of the engine 60 may be controlled by ECUs 10 and 20, and the air intake is adjusted according to an opening degree of the throttle valve adjusted by the ETC (not shown). A driving torque of the motor 70 is adjusted under the control of the MCU 30 to generate a recovery brake torque according to a recovery brake value during a recovery braking operation.

The engine clutch 80 may be disposed between the engine 60 and the motor 70, and is operated by the HCU 20 to determine a drive mode. In the transmission 90, a sum of torques of the engine 60 and the motor 80 determined as the engine clutch 80 is coupled and released may be supplied as an input torque, and an arbitrary gearshift state may be selected according to the speed and driving conditions in the vehicle to provide a driving force to driving wheels 100.

An operation of the present invention having the above-described function will be described as follows.

A driving operations of the hybrid vehicle may be controlled according to a general operation, and a detailed description thereof will be omitted. Thus, only an operation of securing a reserve engine torque in an output torque of the engine according to an HCU engine torque request to secure a stable connection between torques will be described.

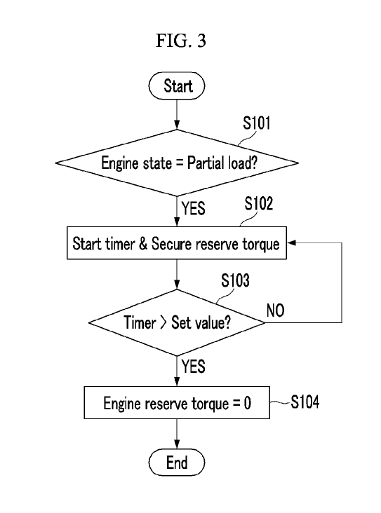

FIG. 3 is a flowchart of a method of controlling an output of a hybrid vehicle according to a first exemplary embodiment of the present invention. As shown in FIG. 3, in the method of controlling an output of a hybrid vehicle according to the first exemplary embodiment of the present invention, first, the ECU 10 determines whether or not the vehicle is in a partial load state once the engine 60 of the vehicle is started and a torque has become controllable (e.g., the controllers have been powered up and are in full operation).

When the vehicle is not in a partial load condition in S101, the control operation is completed. When the vehicle is in a partial load state and the torque is controllable, a timer is started from a point in time when the torque is controllable according to a requested torque of the HCU 20, and an engine reserve torque is secured in an output torque of the engine 60 to secure a quick response to a torque request from the HCU 20 (S102).

In S102, is the ECU may determine whether or not a preset value has been exceeded in a timer (S103). That is, once a certain period of time has passed the reserve engine torque can be released, so the system monitors a timer to determine when this point in time has occurred. Thus, when the time of the timer has not exceeded the preset value, the step returns to S102, and when the time of the timer has exceeded the preset value, a reserve engine torque 60 is set to 0 so that the engine reserve torque is released (S104).

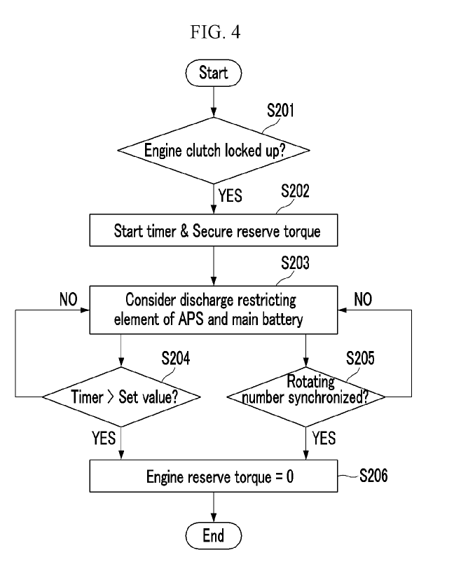

FIG. 4 is a flowchart of a method of controlling a torque of a hybrid vehicle according to a second exemplary embodiment of the present invention. As shown in FIG. 4, in the method of controlling a torque of a hybrid vehicle according to the second exemplary embodiment of the present invention, the ECU 10 of the vehicle analyzes control information of the HCU 20 through a network and determines whether or not the engine clutch 80 is engaged (S201). When the engine clutch 80 is engaged, the timer is started and an engine reserve torque of the engine 60 is secured to secure a response to the torque requested by the HCU 20 (S202).

In one or a plurality of exemplary embodiments, a maximum value or a magnitude of the engine reserve torque of the engine 60 may be determined, considering output capacities of the APS and the main battery 40 (S203). Thereafter, it is determined whether or not the timer exceeds a set value (S204), and whether a engine speed of the engine 60 and a motor speed of the motor 70 are synchronized with each other (S205). When one of these conditions are satisfied (i.e., S204 or S205), the engine reserve torque of the engine 60 is set to 0 (S206).

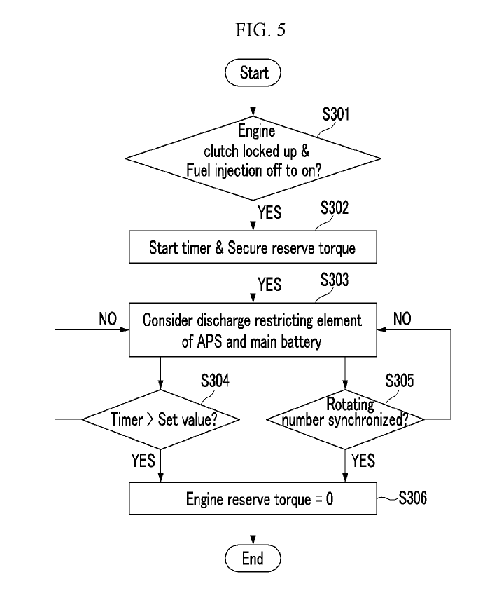

FIG. 5 is a flowchart of a method of controlling a torque of a hybrid vehicle according to a third embodiment of the present invention. As shown in FIG. 5, in the method of controlling a torque of a hybrid vehicle according to the third embodiment of the present invention, first, the ECU 10 of the vehicle determines whether or not the engine clutch 80 is engaged at a speed greater than a present speed and whether the engine fuel injection system 60 has been switched from an on state to an off state (S301). Since its use is not expected at high speeds (for example, higher than 60 kph) when a driver accelerates, the fuel injection system is switch off when the engine clutch 80 is engaged and the HCU 20 controls the engine 60/motor 70 so that the vehicle is driven as if the fuel has been cut to the vehicle. In this condition, the HCU 20 provides fuel injection only when a driver requires acceleration to increase a torque output of the engine 60. Thus, in this case, since an output of the engine 60 may be delayed, an engine reserve torque is secured to improve its response time (S302).

In one or a plurality of exemplary embodiments, a maximum value or a magnitude of the engine reserve torque of the engine 60 may be determined, considering output capacities of the APS and the main battery 40 (S303). Thereafter, it is determined whether or not the timer exceeds a set value (S304), and whether the speed of the engine 60 and the speed of the motor 70 are synchronized with each other (S305). When the timer exceeds the set time or a rotating number of the engine 60 is synchronized with a rotating number of the motor 70, an engine reserve torque of the engine 60 is reset (set) to 0 (S306).

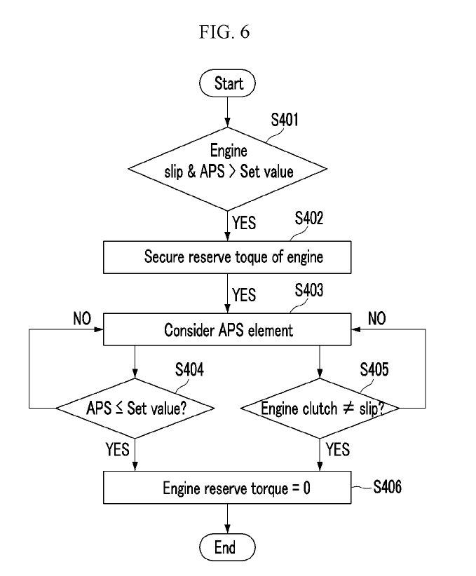

FIG. 6 is a flowchart of a method of controlling an output of a hybrid vehicle according to a fourth exemplary embodiment of the present invention. As shown in FIG. 6, in the method of controlling an output of a hybrid vehicle according a fourth exemplary embodiment of the present invention, first, the ECU 10 of the vehicle determines whether or not the engine clutch 80 is engaging and the APS exceeds a specific value (S401). When the speed of the motor 70 is synchronized with the speed of the engine clutch 80 where the output of the battery 40 is restricted or when there is a problem with the motor 70 so that the engine remains in an idling state, since the speed of the motor 70 needs to be increased via the engine 60 and the engine 60 is in an idling state, the torque response of the engine 60 may be delayed. Thus, when the engine clutch 80 is slipping and the APS exceeds the specific value, an engine reserve torque preferably is secured in an output torque of the engine 60 to secure a response to a torque required by the HCU 20 (S402).

In one or a plurality of exemplary embodiments, a magnitude of an engine reserve torque of the engine 60 may be controlled according to a condition of the APS (S403). Thereafter, the ECU 10 determines whether or not the engine clutch 80 is slipping, and determines whether or not the APS is less than a specific value (S405). When the engine clutch 80 is slipping or the APS is less than the specific value, the engine reserve torque of the engine 60 is reset to 0 to release the engine reserve torque (S406).

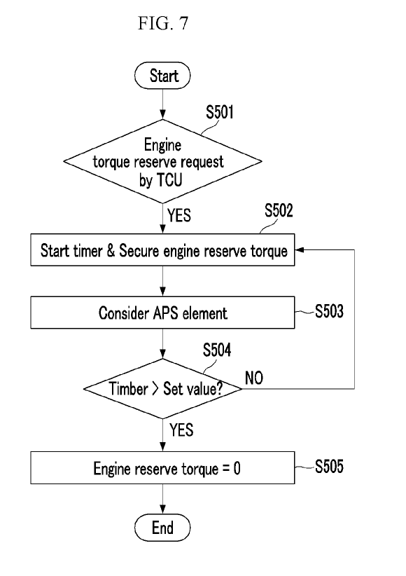

FIG. 7 is a flowchart of a method of an output of a hybrid vehicle according to a fifth exemplary embodiment of the present invention. As shown in FIG. 7, in the method of an output of a hybrid vehicle according to a fifth exemplary embodiment of the present invention, first, the ECU 10 of the vehicle determines when the TCU of the vehicle requests a torque reserve of the engine (S501). When a driver downshifts, the HCU 20 of the vehicle increases a requested torque of the engine 60 according to an APS condition. The TCU simultaneously recognizes the driver's request by sending a request for a torque response from the engine 60 for the requested torque of the HCU 20 to increase of the speed of the engine 60 once the driver has down shifted. Thus, when the engine 60 requests a torque reserve, the TCU starts the timer and secures an engine reserve torque of the engine 60 (S502) to reduce the response time of the engine.

In one or a plurality of exemplary embodiments, a magnitude of an engine reserve torque is determined, considering an APS element (S503). It is determined whether or not the time of the timer has exceeded the set time (S504), and when the time of the timer has exceeded the set time, the engine reserve torque of the engine 60 is controlled (set) to 0 so that the vehicle returns to a general drive state (S505).

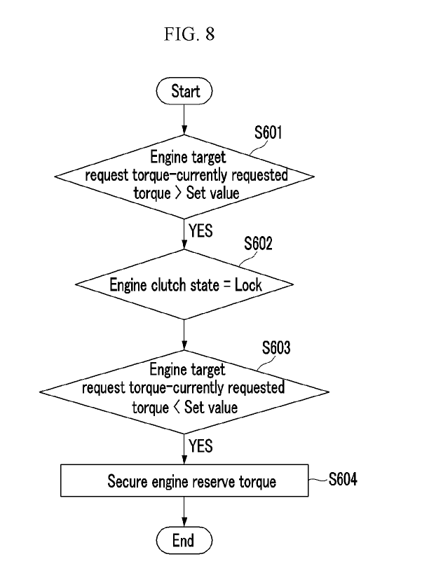

FIG. 8 is a flowchart of a method of controlling an output of a hybrid vehicle according to a sixth exemplary embodiment of the present invention. As shown in FIG. 8, in the controlling an output of a hybrid vehicle according to the sixth exemplary embodiment of the present invention, first, the ECU 10 of the vehicle determines when a difference value between a target request toque of the engine 60 and a currently requested torque exceeds a set value (S601). When the HCU 20 increases the amount of torque requested from the engine 60, an engine reserve torque of the engine 60 is secured based on a difference between a target request torque of the engine 60 sent from the HCU 20 to a network CAN and a currently requested torque.

When the difference value exceeds the set value, the engine clutch 80 of the engine 60 is engaged (S602), the HCU 20 receives an currently requested torque increase inclination from the engine 60 over a predetermined interval period (for example, 10 ms). When increased torque from the engine is requested, the engine management system (EMS) or ECU 10 of the vehicle improves the response time by using a target request torque, a currently requested torque and a requested torque increase inclination of the engine 60 transmitted from the HCU 20.

Next, it is determined whether or not a difference value between a target request torque of the engine 60 and a currently requested torque is less than a set value (S603), and when the difference value is less than the set value, an engine reserve torque of the engine 60 is secured (S604). In one or a plurality of exemplary embodiments, an engine reserve torque of the engine 60 can be determined, considering a torque increase inclination of the engine 60 transmitted from the HCU 20 of the vehicle and an APS element.

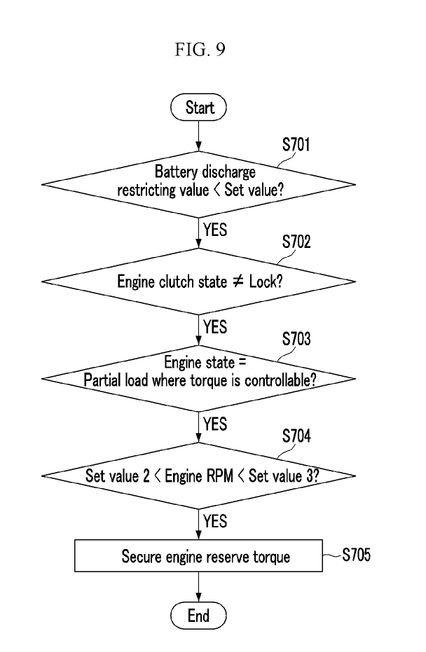

FIG. 9 is a flowchart of a method of controlling an output of a hybrid vehicle according to a seventh exemplary embodiment of the present invention. As shown in FIG. 9, in the method of controlling an output of a hybrid vehicle according to the seventh exemplary embodiment of the present invention, first, the ECU 10 of the vehicle determines whether a discharge capacity of a main battery transmitted from the BMS 50 is less than a set value (S701). In particular, when a vehicle is started and driven in, e.g., on a winter morning, the rate discharge capacity from the main battery 40 becomes frequently no more than 50%. For example, in the case of an HSG for coupling the motor 70 and the engine 60, power supplied from the main battery 40 is insufficient and a speed control for coupling the motor 70 and the engine 60 cannot be smoothly performed. Thus, in this case, when the HCU 20 increases the torque of the engine 60 to couple the engine clutch 80 in a specific condition. Thus, the illustrative embodiment of the present invention is able to reduce the torque response time a of the engine 60 by securing an engine reserve torque of the engine 60 ahead of time when these conditions are present.

Accordingly, when the discharge capacity of the main battery is less than a set value, (b) the ECU may be configured to determine when the engine clutch 80 is disengaged or engaged (S702), and (c) when the engine is in a partial load state where a torque is controllable (S703), and (d) it is determined whether or not an RPM of the engine 60 falls within a preset range (S704).

As shown in FIG. 9, when (a) to (d) are satisfied, the response time of the torque of an engine 60 is improved by securing an engine reserve torque of the engine 60 (S705). In one or a plurality of exemplary embodiments, a magnitude of an engine reserve torque of the engine 60 may be determined, considering a torque of an engine due to an RPM of the engine 60 and a discharge restricting element of the main battery 40.

In the method of controlling an output of a hybrid vehicle according to the eighth exemplary embodiment of the present invention, an output of the hybrid vehicle can be controlled through at least one of the output control methods of the hybrid vehicle according to the first to seventh exemplary embodiment of the present invention.

While the methods of controlling an output of a hybrid vehicle according to the first to seventh exemplary embodiments of the present invention provides an engine reserve torque operation of the engine 60 suitable for various situations, the method according to the eighth exemplary embodiment combines various situations to provide a method of controlling the overall output of a hybrid vehicle.

In one or a plurality of exemplary embodiments, the method of controlling an output of a hybrid vehicle according to the eighth exemplary embodiment includes all the methods of controlling an output of a hybrid vehicle according to the first to seventh exemplary embodiments to combine the methods and control an output of the hybrid vehicle according to the situations.

A maximum value or a magnitude of an engine reserve torque of the engine 60 to which the method of controlling an output of a hybrid vehicle according to the eighth exemplary embodiment of the present invention can be determined, considering all the magnitudes of the engine reserve torques of the engine according to the first to seventh exemplary embodiments.

According to the method of controlling an output of the hybrid vehicle according to the eighth exemplary embodiment, since the ECU 10 precisely controls an output of the vehicle depending on at least the various seven conditions according to the first to seventh exemplary embodiments, fuel efficiency can be secured and a drivability and a comfort of a driver can be significantly improved through accurate torque response of the engine 60.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of controlling an output of a hybrid vehicle, comprising:
determining, by a control unit, when an engine is started and is in a partial load state where a torque is controllable;
in response to determining that the engine is in a partial load state, starting, by the control unit, a timer and securing an engine reserve torque;
monitoring the timer, by the control unit, to determine whether or not the timer has exceeded a set time; and
resetting, by the control unit, the engine reserve torque to be 0 when the set time is exceeded by the timer.

2. A method of controlling an output of a hybrid vehicle, comprising:
determining, by a control unit, whether or not a clutch of the engine is engaged;
starting, by the control unit, a timer and securing an engine reserve torque when the clutch of the engine is engaged;
determining, by the control unit, when the timer exceeds a set value and when a speed of the engine is synchronized with a speed of the motor; and
resetting, by the control unit, the engine reserve torque of the engine to be 0, when the timer exceeds the set value, or when the speed of the engine is synchronized with the speed of the motor.

3. A method of controlling an output of a hybrid vehicle, comprising:
determining, by a control unit, when a clutch of an engine is engaged and an engine fuel injection system is switched from an off state to an on state at a speed which is greater than a preset speed;
securing, by the control unit, an engine reserve torque, when the engine fuel injection system is switched from the off state to the on state and starting a timer;
determining, by the control unit, when the timer exceeds a set time and when the speed of the engine is synchronized with the speed of a motor; and
resetting, by the control unit, an engine reserve torque to be 0 when the timer exceeds the set time or the speed of the engine is synchronized with the speed of the motor.

4. A method of controlling an output of a hybrid vehicle, comprising:
determining, by a control unit, whether or not an acceleration pedal sensor (APS) exceeds a specific value once an engine clutch engaged;
securing, by the control unit, an engine reserve torque, once the engine clutch is engaged and the APS exceeds the specific value;
determining, by the control unit, when the engine clutch has been disengaged and the APS is less than the specific value; and
resetting, by the control unit, the engine reserve torque of the engine to be 0 when the engine clutch is disengaged and the APS is less than the specific value.

5. A method of controlling an output of a hybrid vehicle, comprising:
determining, by a control unit, when a torque reserve request of an engine is made by a transmission control unit (TCU) of the hybrid vehicle;
starting, by the control unit, a timer and securing an engine reserve torque when a torque reserve request of the engine is made;
determining, by the control unit, when the timer exceeds a set time; and
resetting, by the control unit, the engine reserve torque to be 0 when the set time is exceeded.

6. A method of controlling an output of a hybrid vehicle, comprising:
determining, by a control unit, when a difference value between a target request torque of an engine and a currently requested torque exceeds a set value;
engaging, by the control unit, a clutch of the engine when the set value is exceeded;
determining, by the control unit, when the difference value between the target request torque of the engine and the currently requested torque is less than the set value; and
securing, by the control unit, an engine reserve torque when the difference value between the target request torque of the engine and the currently requested torque is less than the set value.

7. A method of controlling an output of a hybrid vehicle, comprising:
(a) determining, by a control unit, a discharge capacity of a main battery;
(b) determining, by the control unit, whether a clutch of an engine is disengaged or engaging;
(c) determining, by the control unit, when the engine is in a partial load state where a torque is controllable;
(d) determining, by the control unit, when an RPM of the engine is within a preset range; and
(e) securing, by the control unit, an engine reserve torque of the engine when all of (a) to (d) are satisfied.
